(19) United States
(12) Patent Application Publication
(10) Pub. No.: US 2012/0057335 A1
(43) Pub. Date: Mar. 8, 2012

(54) Flashlight with Angle Adjustment Assembly

(76) Inventor: Ching-Hsiang Wang, Tainan City (TW)

(21) Appl. No.: 12/874,315

(22) Filed: Sep. 2, 2010

(51) Int. Cl. F21L 4/00

(52) U.S. Cl. 362/197

(57) ABSTRACT

A flashlight with an angle adjustment assembly is disclosed. The angle adjustment assembly includes: arcuate receiving areas bilaterally and concavely provided on a lighting portion of the flashlight; inserts which correspond in shape to the receiving areas, are received respectively therein, and are each penetrated by plural holes; receiving cavities bilaterally and concavely provided in a pivot space of a flashlight body of the flashlight; and limiting elements which correspond in shape to the receiving cavities, are received respectively therein, and each have a projection. The holes of the inserts bilaterally provided on the lighting portion are engageable sequentially, in a forward or backward direction, with the projections of the limiting elements bilaterally provided in the pivot space, so as to adjust the lighting portion to the desired angle. Thus, the flashlight can be used horizontally or placed vertically on a desk as a desk lamp with adjustable lighting angle.

### BACKGROUND OF THE INVENTION

1. Technical Field

The present invention relates to flashlights for illumination purposes and, more particularly, to a flashlight with an angle adjustment assembly, wherein the lighting angle of the flashlight is adjustable by sequential engagement, in a forward or backward direction, between a plurality of arcuately arranged holes bilaterally provided on a predetermined part of a lighting portion and projections outwardly extended from a part of a flashlight body that corresponds in position to the predetermined part of the lighting portion. The engagement between the holes and the projections also allows the lighting portion to be fixed at the desired angle. Hence, the flashlight not only can be carried around and used horizontally for lighting, but also can be placed vertically on a desk and serve as a desk lamp with adjustable lighting angle.

2.Description of Related Art

Flashlights which are designed for illumination and capable of lighting angle adjustment are typically equipped with angle adjusting elements either on the flashlights themselves or on frames supporting the flashlights. These angle adjusting elements allow users to change the lighting directions of the flashlights as needed.

### BRIEF SUMMARY OF THE INVENTION

The present invention discloses a novel configuration of angle adjustment assemblies for use in flashlights. The disclosed angle adjustment assembly for a flashlight works on the engagement and forward/backward rotation between a plurality of arcuately arranged holes which are bilaterally provided on a predetermined part of a lighting portion of the flashlight and projections which extend outward from a part of a flashlight body of the flashlight that corresponds in position to the predetermined part of the lighting portion. The aforesaid engagement and forward/backward rotation allow the lighting portion to be adjusted to and fixed at the desired angle. Therefore, in addition to being carried around and used in a horizontal position for illumination, the flashlight can be placed vertically on a desk and used as a desk lamp with adjustable lighting angle, thus increasing the flexibility of use of the flashlight.

The primary object of the present invention is to provide a flashlight with an angle adjustment assembly. The flashlight includes a flashlight body, a middle frame, a bottom portion, and a lighting portion, wherein the flashlight body is connected with a handle. The angle adjustment assembly includes: arcuate receiving areas which are bilaterally and concavely provided on a predetermined part of the lighting portion; inserts which correspond in shape to the receiving areas, are received respectively in the receiving areas, and are each penetrated by a plurality of holes; receiving cavities which are bilaterally and concavely provided in a pivot space of the flashlight body that corresponds in position to the predetermined part of the lighting portion; and limiting elements which correspond in shape to the receiving cavities, are received respectively in the receiving cavities, and are each outwardly extended with a projection. The holes of the inserts bilaterally provided on the lighting portion are engageable with the projections of the limiting elements bilaterally provided in the pivot space of the flashlight body. When it is desired to adjust the angle of the lighting portion of the flashlight, the holes bilaterally provided on the lighting portion are engaged sequentially, in a forward or backward direction, with the projections of the limiting elements on the flashlight body until the lighting portion is adjusted to and fixed at the desired lighting direction. Thus, the flashlight not only can be carried around and used horizontally for lighting, but also can be placed vertically on a desk and serve as a desk lamp with adjustable lighting angle.

The second object of the present invention is to provide the foregoing flashlight, wherein the flashlight body connected with the handle has a rear portion concavely provided with a space in which a plurality of LEDs are installed and whose opening is peripherally connected with a transparent cover. While the lighting portion of the flashlight is in use, the LEDs on the rear portion of the flashlight body are turned on to alert people approaching from behind and provide a guiding function.

The third object of the present invention is to provide the foregoing flashlight, wherein the handle connected to one side of the flashlight body has a lower portion formed with a resilient gripping surface that furnishes an anti-slip function when the handle is held by a human hand.

### BRIEF DESCRIPTION OF THE SEVERAL VIEWS OF THE DRAWINGS

The invention as well as a preferred mode of use, further objects, and advantages thereof will be best understood by referring to the following detailed description of an illustrative embodiment in conjunction with the accompanying drawings, in which:

FIG. 1 is an exploded perspective view of a flashlight with an angle adjustment assembly according to the present invention;

FIG. 2 is an assembled perspective view of the flashlight shown in FIG. 1;

FIG. 3 is a side elevation of the flashlight shown in FIG. 1;

FIG. 4 shows the flashlight of FIG. 1 in a vertical position;

FIG. 5 is a detailed view of the area 50 in FIG. 4;

FIG. 6 illustrates angle adjustment of the flashlight shown in FIG. 1; and

FIG. 7 is a detailed view of the area 70 in FIG. 6.

### DETAILED DESCRIPTION OF THE INVENTION

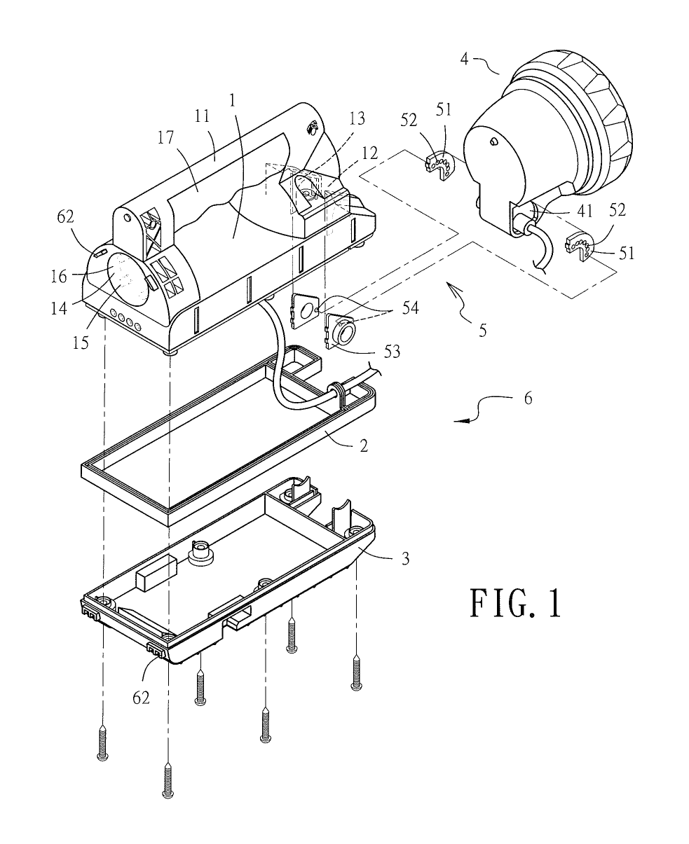

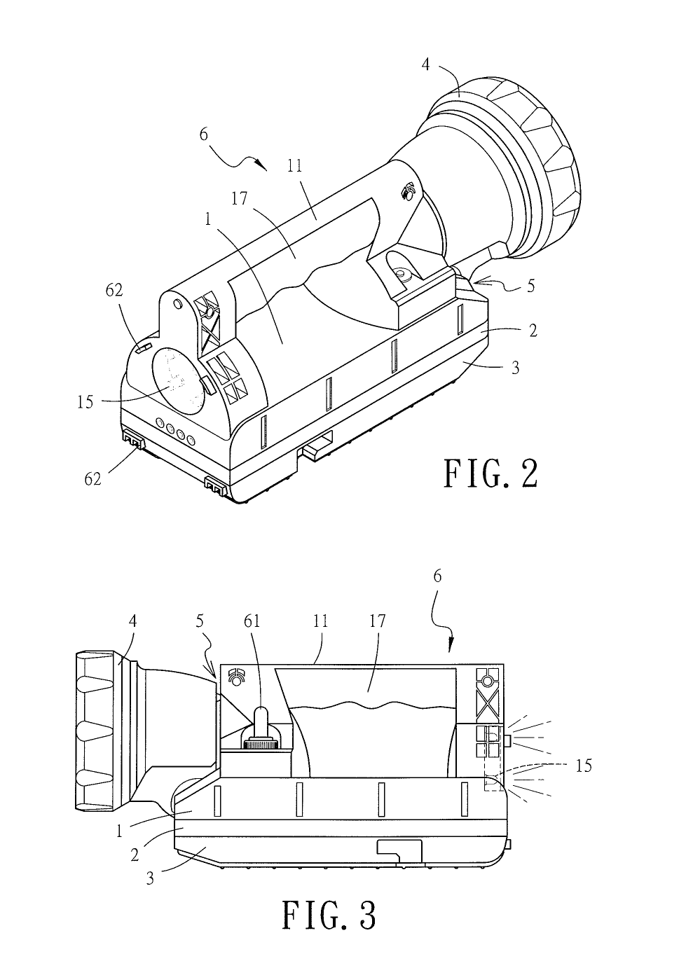

Referring to FIG. 1 and FIG. 2 for an embodiment of the present invention, a flashlight 6 with an angle adjustment assembly 5 includes a flashlight body 1, a middle frame 2, a bottom portion 3, and a lighting portion 4, wherein the flashlight body 1 is connected with a handle 11.

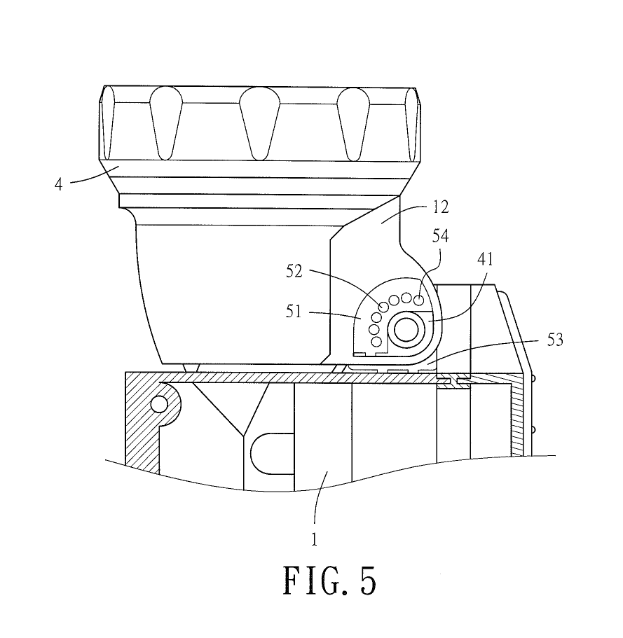

As shown in FIG. 1, the angle adjustment assembly 5 of the flashlight 6 includes: arcuate receiving areas 41 which are bilaterally and concavely provided on a predetermined part of the lighting portion 4; inserts 51 which correspond in shape to the receiving areas 41, are received respectively in the receiving areas 41, and are each penetrated by a plurality of holes 52 (see FIG. 5); receiving cavities 13 which are bilaterally and concavely provided in a pivot space 12 of the flashlight body 1, wherein the pivot space 12 corresponds in position to the predetermined part of the lighting portion 4 (see FIG. 1); and limiting elements 53 which correspond in shape to the receiving cavities 13, are received respectively in the receiving cavities 13, and are each outwardly extended with a projection 54 (see FIGS. 1, 5).

Referring to FIG. 5, in order to install the lighting portion 4 to the flashlight body 1, the holes 52 of the inserts 51 bilaterally provided on the lighting portion 4 are aligned and engaged with the projections 54 of the limiting elements 53 bilaterally provided in the pivot space 12 of the flashlight body 1. Thus, the lighting portion 4 is assembled to the front end of the flashlight body 1 in such a way that the lighting portion 4 is angularly adjustable.

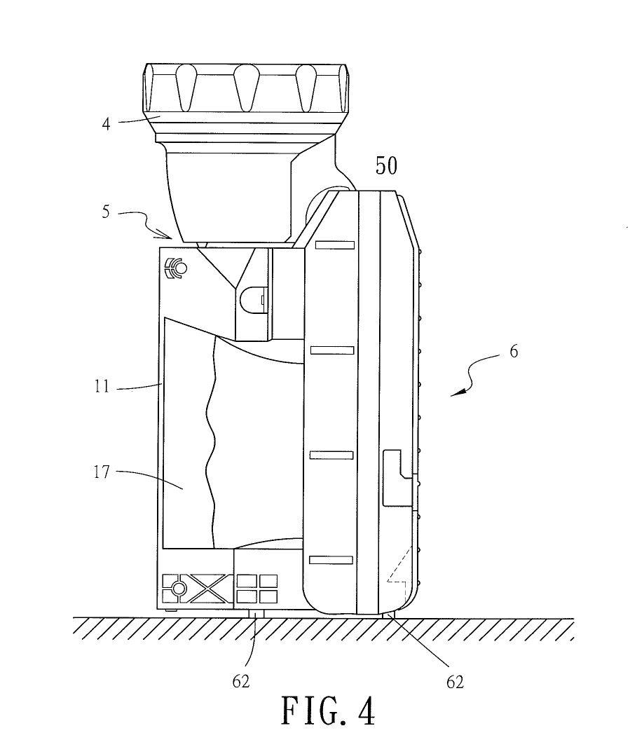

In addition, as shown in FIG. 2, a space 14 is concavely formed at a rear portion of the flashlight body 1 and provided with a plurality of LEDs 15. A transparent cover 16 is coupled to the periphery of the opening of the space 14. When the lighting portion 4 of the flashlight 6 is turned on by pulling a toggle switch 61, as shown in FIG. 3, the LEDs 15 at the rear portion of the flashlight body 1 are also turned on to alert people coming from behind the flashlight 6 and provide a guiding function. (The toggle switch 61 of the flashlight 6 may also be configured to be activated in two stages, wherein only the lighting portion 4 is turned on in the first stage, and both the lighting portion 4 and the LEDs 15 at the rear portion of the flashlight body 1 are turned on in the second stage.) Furthermore, referring to FIG. 2, a plurality of anti-slip elements 62 are extended from predetermined positions of a rear portion of the flashlight 6, thus allowing the flashlight 6 to stand stably in a vertical position, as shown in FIG. 4.

The handle 11 connected to one side of the flashlight body 1 has a lower portion formed with a resilient gripping surface 17, as shown in FIG. 2. The gripping surface 17 provides an anti-slip function when the handle 11 is gripped by a human hand.

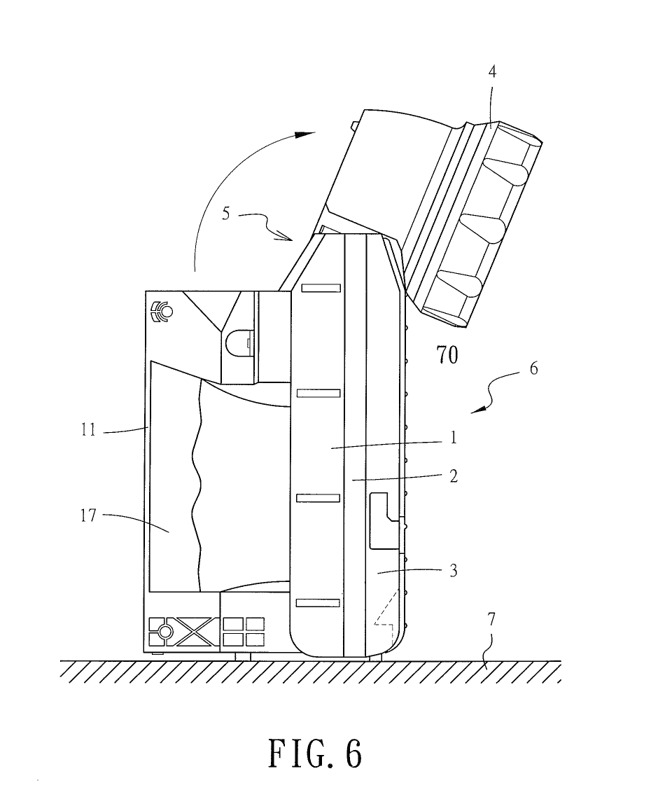

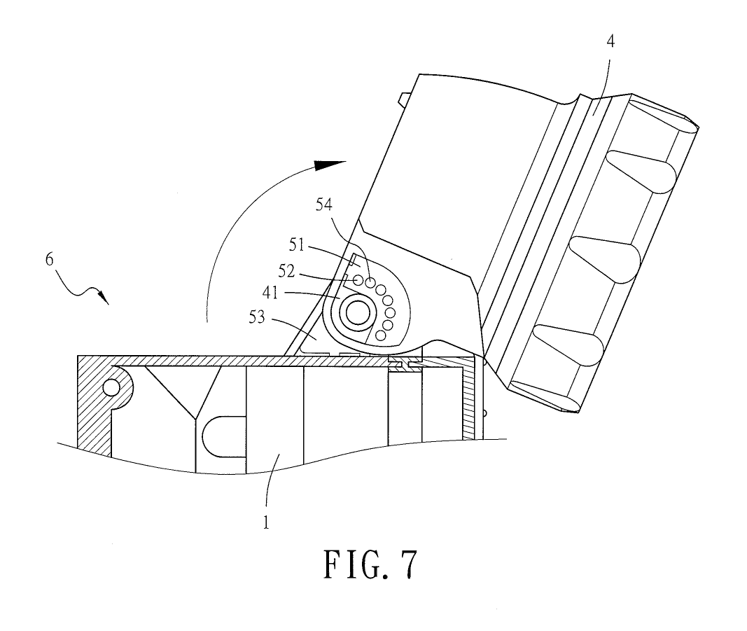

Referring to FIG. 6, to adjust the angle of the lighting portion 4 of the flashlight 6 standing in the vertical position, the holes 52 bilaterally provided on the lighting portion 4 of the flashlight 6 are engaged sequentially, in a forward or backward direction, with the projections 54 of the limiting elements 53 on the flashlight body 1 (as shown more clearly in FIG. 7) until the lighting portion 4 is adjusted to and fixed at the desired lighting angle. Hence, the flashlight 6 not only can be carried around and used horizontally for lighting, but also can stand vertically on a desk 7 and serve as a desk lamp with adjustable lighting angle.

What is claimed is:

1. A flashlight with an angle adjustment assembly, wherein the flashlight comprises a flashlight body, a middle frame, a lower portion, and a lighting portion, the flashlight body being connected with a handle, the flashlight with the angle adjustment assembly being characterized in that the angle adjustment assembly comprises:
arcuate receiving areas which are bilaterally and concavely provided on a predetermined part of the lighting portion;
inserts which correspond in shape to the receiving areas, are received respectively in the receiving areas, and are each penetrated by a plurality of holes;
receiving cavities which are bilaterally and concavely provided in a pivot space of the flashlight body that corresponds in position to the predetermined part of the lighting portion; and
limiting elements which correspond in shape to the receiving cavities, are received respectively in the receiving cavities, and are each outwardly extended with a projection;
wherein the holes of the inserts bilaterally provided on the lighting portion are engageable with the projections of the limiting elements bilaterally provided in the pivot space of the flashlight body, and when it is desired to adjust the lighting portion of the flashlight angularly, the holes bilaterally provided on the lighting portion are engaged sequentially, in a forward or backward direction, with the projections of the limiting elements on the flashlight body until the lighting portion is adjusted to and fixed at a desired lighting direction, thus allowing the flashlight not only to be carried around and used horizontally for lighting, but also to be placed vertically on a desk and used as a desk lamp with adjustable lighting angle.

2. The flashlight of claim 1, wherein the flashlight body connected with the handle has a rear portion concavely formed with a space, the space being installed with a plurality of LEDs and having an opening peripherally connected with a transparent cover, the LEDs at the rear portion of the flashlight body being turned on while the lighting portion of the flashlight is in use, so as to alert people approaching from behind the flashlight and provide a guiding function.

3. The flashlight of claim 1, wherein the handle connected to a side of the flashlight body has a lower portion formed with a resilient gripping surface for providing an anti-slip function when the handle is gripped by a human hand.
